(19) United States
(12) Patent Application Publication
(10) Pub. No.: US 2010/0127088 A1
(43) Pub. Date: May 27, 2010

(54) ELECTRONIC THERMOSTAT WITH MAIN PARAMETERS THAT ARE RAPIDLY SETTABLE EVEN DURING OPERATION OF THE PLANT UNDER CONTROL

(75) Inventor: Adriana Sartor, Milano (IT)

Correspondence Address: J. Rodman Steele;Novak Druce & Quigg LLP, 525 Okeechobee Blvd, Suite 1500, West Palm Beach, FL, 33401, US

(73) Assignee: Elettrotec s.r.I., Milano (IT)

(21) Appl. No.: 12/599,033

(22) PCT Filed: Apr. 29, 2008
(86) PCT No.: PCT/EP2008/055246

§ 371 Date: Nov. 5, 2009

(30) Foreign Application Priority Data
May 7, 2007 (IT) MI 2007 A 00910

(51) Int. Cl. G05D 23/00

(52) U.S. Cl. 236/51; 236/94

(57) ABSTRACT

An electronic thermostat is disclosed comprising a connector (6) provided with means (7) for sealing an outer body (1) provided with a cavity (60) within which there is housed a circuit card (2); the thermostat comprises a temperature sensor (103) exposed to ambient temperature under control and connected to the circuit card. The temperature sensor is a semiconductor sensor and is housed inside a cavity (101) of a flange (100) removably fixed to the body (1). The circuit card (2) is provided with a memory and the thermostat comprises setting means (4) housed inside the cavity of the outer body and comprising at least one button (12-13), said connector (6) being connected to the lateral surface of the outer body (1) and said cavity (60) of the outer body communicating through an opening (73) placed at the head of said body (1) and normally covered by a removable cover (74) to enable the operator to reach said setting means (4).

The present invention relates to an electronic thermostat with main parameters that are rapidly settable even during operation of the plant under control.

Rapid and precise setting is of fundamental importance to optimise the operation of the plant to which said thermostat is applied.

The continuous operating interruptions to the thermostat cause transitory operating situations of the plant to be multiplied that can lead to a fault in the thermostat and to a consequent fault in the plant to which the thermostat is connected.

Currently, thermostats of bimetal sensors are used that are suitable for measuring temperatures that are not below 30° C. Said sensor is, however, not precise, has a reduced temperature measuring range and, above all, after a temperature has been measured, it never returns to the exact start position.

This permits a fixed intervention temperature, so as many bimetal sensors are required as there are intervention temperatures.

Further, the bimetal sensor comprises a blade of conductive metal that expands as the temperature changes, closing a contact; said blade is subject to wear. A given temperature change is not matched by the same blade expansion, so the temperature data are not precise.

The object of the present invention is to make a thermostat with a simple construction but which is more precise than known thermostats and in which it is possible to act on setting means without having to stop the plant to which it is connected and the temperature of which it has to control.

According to the present invention this object is achieved with an electronic thermostat comprising a connector provided with means for sealing an outer body provided with a cavity within which there is housed a circuit card, said thermostat comprising a temperature sensor exposed to ambient temperature under control and connected to said circuit card, characterised in that said temperature sensor is a semiconductor sensor and is housed inside a cavity of a flange fixed to the outer body removably, the circuit card is provided with a memory and the thermostat comprises setting means housed inside the cavity of the outer body and comprising at least one button, said connector being connected to the lateral surface of the outer body and said cavity of the outer body communicating through an opening placed at the head of said body and normally covered by a removable cover to enable the operator to reach said setting means.

The presence of the laterally place connector enables the inside of the cavity to be accessed easily. The connector does not have to be removed as it is sufficient simply to remove the cover, which has no effect on the action of the thermostat, thus enabling the plant to be able to continue to operate even during setting of the thermostat.

These and other features of the present invention will be made clearer from the following detailed description of a practical embodiment thereof given by way of non-limiting example in the attached drawings, in which:

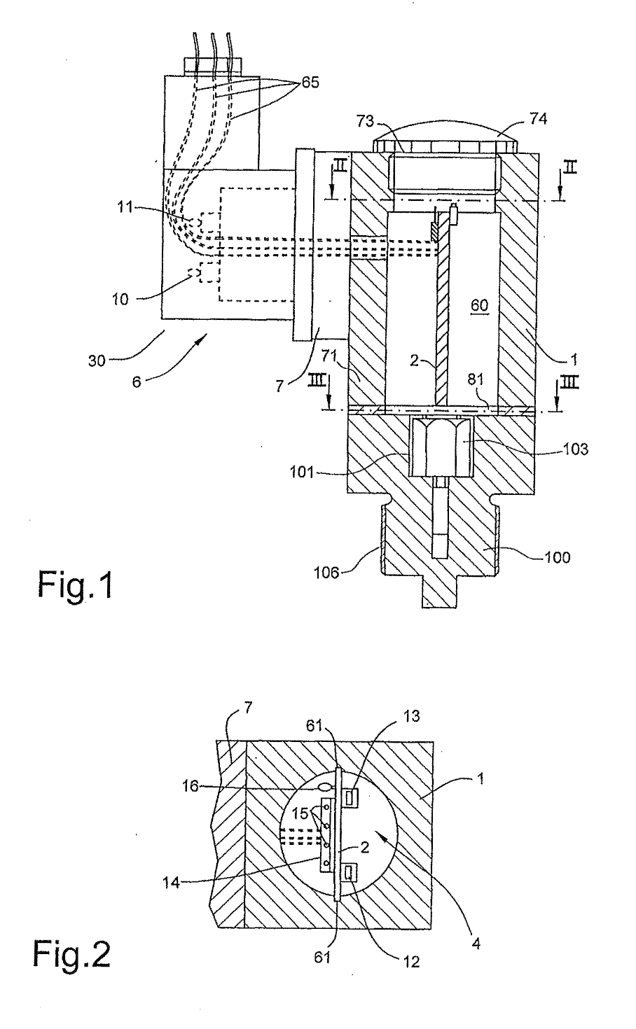

FIG. 1 shows an axially partially sectioned front view of the thermostat according to the present invention;

FIG. 2 shows a section view according to line II-II in FIG. 1;

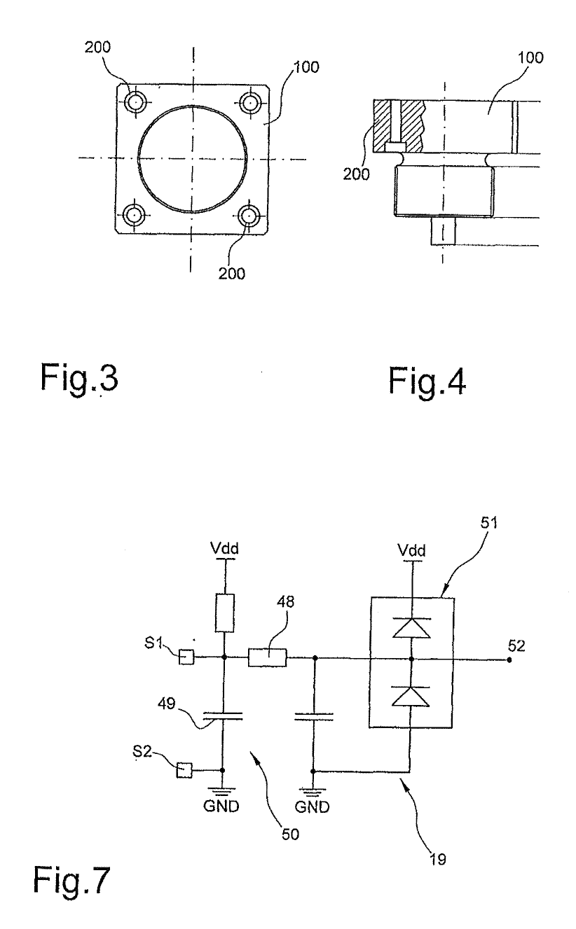

FIG. 3 is a schematic bottom view according to the line III-III in FIG. 1;

FIG. 4 is a partially sectioned schematic view only of the lower part of the thermostat in FIG. 1;

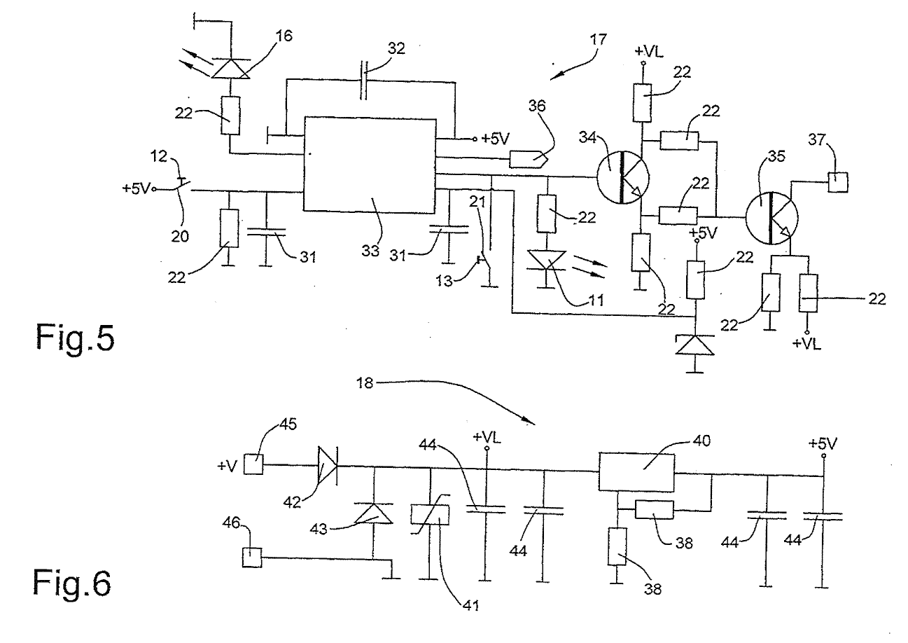

FIG. 5 shows the main part of the circuit card of said thermostat;

FIG. 6 shows a supply and cutout circuit comprised in said circuit card;

FIG. 7 shows a temperature signal input circuit provided by the temperature sensor.

The electronic thermostat shown in FIGS. 1 and 2 comprises an outer body 1 made of aluminium with a cylindrical cavity 60 having a pair of longitudinal grooves 61 that are removably engageable with the ends of an extractable flat circuit card 2.

On the lateral surface of the body 1 a connector 6 is fixed that is provided with a transparent cover 30 and a removable plate 7 for sealing the cavity 60. Inside the connector 6 there are located luminous warning LEDs 10-11 that are able to emit respectively a green and red light that is visible through the transparent cover 30. The connector 6 is further traversed by electric wires 65 for the external electric connection of the circuit card 2.

In the lower part of the body 1 a brass flange 100 is fixed that is provided with a cavity 101 in which a temperature semiconductor sensor 103 is arranged by a thread, preferably a semiconductor sensor of NTC type, with corresponding washer, below which there is a threaded fitting 106 for connecting to the plant at a temperature to be controlled. As is more visible in FIGS. 3 and 4, the flange 100 is fixable to the body 1 by means of screws that can be arranged in suitable threaded holes 200. The threaded fitting may have various dimensions to adapt to various plants to be controlled.

Said flange 100 is disconnectable from the body 1 and in general is made of a material that is more resistant than the body 1 to be able to operate at very high operating temperatures. This is further replaceable with another flange made of various material that is variable according to the desired operating temperature.

The circuit card 2 supports setting means 4 comprising setting buttons 12-13, a luminous warning LED 16 emitting a green light, a luminous warning LED 11 emitting a red light and a serial port 14 provided with connecting pins 15 for connecting by the wires 65 to an external personal computer or other data inputting/data gathering means.

Said buttons 12-13 are reachable by the operator through a threaded opening 73 located at the head of the body 1 and normally closed by a threaded removable cover 74.

From a circuit point of view, said card 2 comprises a main circuit 17 (FIG. 5), a supply and cutout circuit 18 (FIG. 6) and an input circuit 19 for reading the signal coming from the temperature sensor 103 (FIG. 5).

The main circuit 17 comprises switches 20-21 controlled respectively by the setting buttons 12-13, a microprocessor 33 with an internal E²PROM memory and a feedback capacitor 32, a switching transistor 34, a power transistor 35, the LEDs 11 and 16, various resistances 22, stabilising capacitors 31, a Zener diode 60, earth connections, an input 36 and an output 37.

The supply and cutout circuit 18 comprises a pair of input terminals 45-46, cutout diodes 42-43 protecting against voltage reversals, variable resistances 41, a voltage stabiliser-converter 40, resistances 38, capacitors 44 and various earth connections.

Lastly, the input circuit 19 comprises input terminals S1 and S2 that are connected to the NTC semiconductor component of the temperature sensor 103. The input circuit 19 comprises a filter 50, consisting of a resistance 48 and a capacitor 49; the capacitor 50 is coupled between a supply voltage VDD and earth GND and has the terminals connected to the terminals S1 and S2 and the supply voltage VDD supplies the resistant component of the temperature sensor. The input circuit 19 comprises an overvoltage cutout circuit 51 comprising two diodes and connected to an output 52 that is in turn connected to the input 36 of the circuit part 17 in FIG. 5.

Setting the thermostat manually is rather simple.

The green LED 10 is associated with the electric supply circuit of the thermostat (non shown in FIGS. 3-5) with the task of indicating the presence of power.

Let the thermostat be considered mounted on the plant or machine under control with the intervention temperature (for example 60° C.) taken to the desired operating value. This temperature is detected by the semiconductor sensor NTC 103; in fact, as the temperature varies there is a variation in the value of the resistant component of the sensor 103. Said resistive component variation is in turn translated into an electric amplitude signal corresponding to the temperature detected at the output 52 of the input circuit 19 in FIG. 7 and the input 36 of the microprocessor 33 of the circuit part 17 in FIG. 5.

In order to access the setting buttons 12-13, it is sufficient to remove the cover 74. It is not necessary to stop the plant or the machine at a temperature under control. When the thermostat is powered up the green LED 10 on the connector 6 switches on.

By keeping the button 12 pressed for at least three seconds the input 36 temperature value is acquired as an intervention value by the memory of the microprocessor 33, with a consequent luminous confirmation by the green LED 16.

Each acquisition of a new intervention value also automatically sets the reset threshold (hysteresis) according to a minimum hysteresis value.

In order to set a different reset threshold, the plant has to be taken to the desired reset temperature and then the white button 13 has to be kept pressed for at least three seconds. Also in this case the green LED 16 will light up to confirm that the reset value has been acquired by the microprocessor 33 and corresponding memory.

Once the thermostat has been set, the opening 73 can again be covered with the cover 74.

During operation, the luminous red LED 41 located on the connector 6 lights up to indicate that the set switching value has been reached. In turn, the transistors 34 and 35 are switched by the microprocessor 33 in saturation or blocking status to indicate electrically to the exterior, by the wires 65, the intervention or resetting status of the thermostat.

If it is necessary to program the instrument again it is merely necessary to repeat the aforesaid procedure with different temperature values.

Before a new value is acquired (intervention or reset) a test is run on the E²PROM memory. This test is indicated by the green LED flashing in rapid succession before the visual datum acquisition signal.

In addition to significant setting rapidity, said thermostat is very flexible inasmuch as there exists the possibility, by pressing the buttons 12-13 simultaneously for a few seconds, of transforming an operating mode with “normally open” contact (i.e. with output 37 in FIG. 5 normally devoid of signal) into an operating mode with “normally closed” contact (i.e. with output 37 normally with a signal). In practice, two thermostats in one are obtained.

More precisely, the NTC sensor 103 detects the operating temperature of the plant to be controlled. As the temperature varies the resistive value of the sensor varies, creating a voltage variation on the output 52 in FIG. 7 and the input 36 in FIG. 5 and the application of a temperature signal to the microprocessor 33. The latter then commands the blocking of the transistor 34, which in turn leads to the blocking of the power transistor 35. The red LED 11 commanded by the diode 41 lights up.

The card 2 is further provided with a cutout circuit 18 for possible short circuits and incorrect electric connections.

The opposite pattern, with saturation of the transistors 34 and 35 and switching of the red LED 11, is caused by the return of the temperature below the reset threshold.

Lastly, the setting buttons 12-13 can be used to enter codes for locking/unlocking programming. The operator can perform setting operations only if he knows the set combination of buttons 12-13 (for example, button 12 is pressed twice, button 13 is pressed once and button 12 is pressed three times again). This code is managed by software integrated into the circuit card 2.

The thermostat according to the present invention enables working with the greatest safety, the basic operating parameters to be set rapidly and frequent maintenance interventions to be avoided.

It is possible to obtain rapid programming of the thermostat without having to disconnect the supply and without using specific tools but only minimal pressure on the buttons by the operator. Further, the thermostat enables calibration to be performed on the plant and not in the workshop; in this manner it is possible to modify rapidly the calibrating values according to customer needs,

With the thermostat according to the present invention it is possible to have a wider range of temperature readings than with known thermostats, i.e. from −20° C. to 90° C. with precision of ±3° C.

1. Electronic thermostat comprising a connector (6) provided with means (7) for sealing an outer body (1) provided with a cavity (60) within which there is housed a circuit card (2), said thermostat comprising a temperature sensor (103) exposed to ambient temperature under control and connected to said circuit card, characterised in that said temperature sensor is a semiconductor sensor and is housed inside a cavity (101) of a flange (100) fixed to the outer body (1) removably, the circuit card (2) is provided with a memory and the thermostat comprises setting means (4) housed inside the cavity of the outer body and comprising at least one button (12-13), said connector (6) being connected to the lateral surface of the outer body (1) and said cavity (60) of the outer body communicating through an opening (73) placed at the head of said body(1) and normally covered by a removable cover (74) to enable the operator to reach said setting means (4).

2. Thermostat according to claim 1, characterised in that said flange (100) is connected to the outer body (1) at the end opposite the end where there is said opening (73) with removable cover (74), said flange (100) comprising a thread (106) for connecting with the environment to be controlled.

3. Thermostat according to claim 2, characterised in that said flange (100) is made of material that is more resistant than the outer body (1).

4. Thermostat according to claim 1, characterised in that said setting means (4) acts on software integrated into the card (2) so as to enable setting by locking code managed by the software to be prohibited.

5. Electronic thermostat according to claim 1, characterised in that said setting means (4) comprises a first button (12) for setting the intervention value and a second button (13) for setting the reset value.

6. Thermostat according to claim 4, characterised in that said locking code is entered by the operator by said first (12) and second (13) setting button.

7. Thermostat according to claim 1, characterised in that it comprises a luminous LED (10) indicating the presence of power.

8. Thermostat according to claim 1, characterised in that it comprises a luminous LED (11) indicating that the set switching value has been reached.

9. Thermostat according to claim 1, characterised in that it comprises a luminous LED (16) indicating the setting of the intervention value, of the reset value and of the type of output contact.

10. Thermostat according to claim 1, characterised in that said semiconductor sensor (103) is of the NTC type (103).

11. Thermostat according to claim 1, characterised in that said temperature semiconductor sensor comprises a resistance that varies with the varying of the temperature, said resistance being supplied electrically and producing electric voltage with an amplitude corresponding to the detected temperature, said circuit card (2) comprising a microprocessor (33) provided with a memory, which receives said voltage signal produced by the temperature sensor and determines in function thereof whether an output signal is present or not, said setting means (4) acting on the microprocessor (33) for memorising the voltage signal values that represent the intervention and reset values of the thermostat.
